(19) United States
(12) Patent Application Publication
(10) Pub. No.: US 2020/0065819 A1
(43) Pub. Date: Feb. 27, 2020

(54) SYSTEM AND METHOD FOR LINKING PAYMENT CARD TO PAYMENT ACCOUNT

(71) Applicant: MASTERCARD INTERNATIONAL INCORPORATED, PURCHASE, NY (US)

(72) Inventor: Andres Gonzalez, Doral, FL (US)

(21) Appl. No.: 16/106,529

(22) Filed: Aug. 21, 2018

(51) Int. Cl. G06Q 20/40; G06Q 20/36

(52) U.S. Cl. CPC G06Q 20/4093; G06Q 20/363; G06Q 20/4012; G06Q 20/40145

(57) ABSTRACT

A request is received from an account holder to link a payment card to a payment card account owned by an account holder. The request is submitted by the account holder and receipt of the request includes receiving a payment card identification number displayed in association with the payment card. The payment card identification number is used to look up a payment token electronically stored in the payment card. The payment card identification number is different from the payment token. The payment token is mapped to a payment card account number that identifies the payment card account owned by the account holder.

### BACKGROUND

FIG. 1 is a block diagram that illustrates a conventional payment card system 100.

The payment card system 100 includes a customer device 102 such as a magnetic stripe card, a payment IC (integrated circuit) card (contactless and/or contact), or a payment-enabled mobile device (such as a smartphone that includes a payment application), a merchant device 104, an acquirer financial institution (FI) computer 106, a card network (also referred to as a “payment network”) 108, and an issuer FI computer 110.

The merchant device 104 may be, for example, a POS (point of sale) terminal/card reader or a merchant mobile device (i.e., a smartphone), and may also be considered part of the payment card account system 100. The customer device 102 may be presented to the merchant device 104 to consummate a purchase transaction and to permit the merchant device 104 to read payment card account data (including, for example, a payment account number) from the customer device 102. In other situations, the merchant device 104 may be an e-commerce server computer, and the customer device 102 may be a personal computer or a mobile device running mobile browser software or the like. In this case, the customer device 102 may engage in an online shopping session with an e-commerce website hosted by the merchant device 104.

During a purchase transaction, the acquirer FI computer 106 may receive a payment account system transaction authorization request message for the transaction from the merchant device 104. The acquirer FI computer 106 may then route the authorization request message via a card network 108 to an issuer FI computer 110, which is operated by the issuer of a payment account that is associated with the account number obtained by the merchant device 104 (e.g., from the customer device 102) and included in the transaction authorization request message. In some implementations, the transaction authorization response message generated by the payment issuer server computer 110 is routed back to the merchant device 104 via the card network 108 and the acquirer FI computer 106.

One well known example of a payment card network is referred to as the “Banknet” system, and is operated by Mastercard International Incorporated, the assignee of the present application.

Referring again to FIG. 1, the payment account issuer FI computer 110 may be operated by or on behalf of a financial institution, such as a bank, that issues payment accounts to individual users (such as the customer or consumer who presented or operated the customer device 102 referred to above). For example, the payment account issuer FI computer 110 may perform such functions as (a) receiving and responding to requests for authorization of payment account transactions to be charged to payment accounts issued by the FI; and (b) tracking and storing transactions and maintaining account records.

It should be understood that the components shown in the system 100 of FIG. 1 are only those that are needed for processing a single transaction. However, a typical or practical payment system may process hundreds, thousands or more purchase transactions per day (including simultaneous transactions), and thus may include a considerable number of payment account issuers and their computers and/or computer networks, a considerable number of acquirers and their computers and/or computer networks, and numerous merchants and their devices, as well as a very large number of customer devices.

Many of the payment devices currently being issued by account issuers are contact IC payment cards, which are read by direct electrically conductive connection with card readers that are part of merchant devices. In many cases, the cards issued to account holders are not also “contactless” cards—that is, the cards do not support being read contactlessly at the point of sale or “point of interaction”. Although contact reading of payment cards is fairly expeditious, contactless reading, with just a tap of the card on the reader, may be noticeably faster. However, the “tap to pay” type of transaction is not possible when the payment card in question lacks contactless capabilities. Thus users may in many situations prefer the convenience of contactless card-reading transactions. However, many issuers prefer to avoid the additional cost of issuing cards that have contactless capabilities along with contact-readability.

When the customer device is a payment-enabled mobile device, typically the reading transaction itself is contactless. Nevertheless, some user interaction with the device may be required to prepare the device for the “tap to pay” reading of the payment-enabled mobile device at the point of interaction. Consequently, a payment-enabled mobile device may be sub-optimal when a very rapid reading transaction is desired, as—for example—when the transaction is for entry at the turnstile or gate of a mass transit system.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments, wherein:

FIG. 1 is a block diagram that illustrates a conventional payment card account system.

FIG. 2 is a block diagram that illustrates aspects of an embodiment of a card-to-account linking system provided in accordance with aspects of the present disclosure.

FIG. 3 is a simplified plan view of a card that may be utilized in the system of FIG. 2.

FIG. 4 is a schematic plan view showing internal components of the card shown in

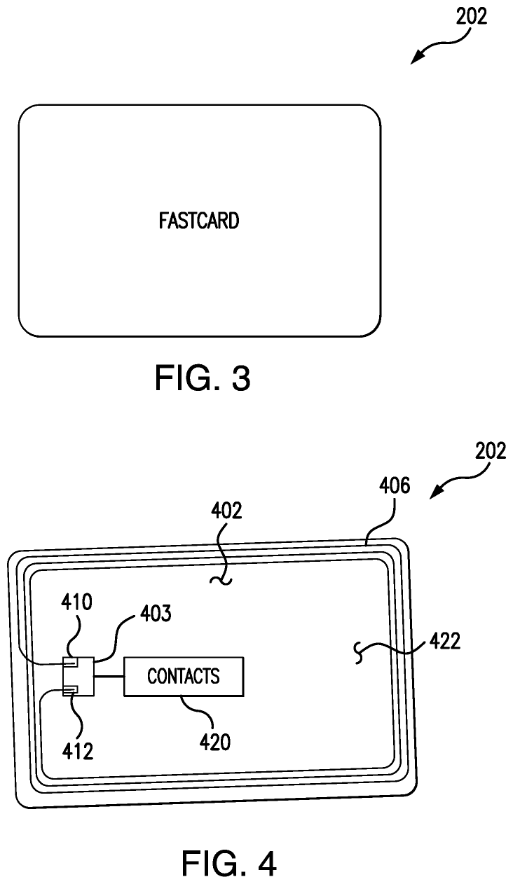

FIG. 3.

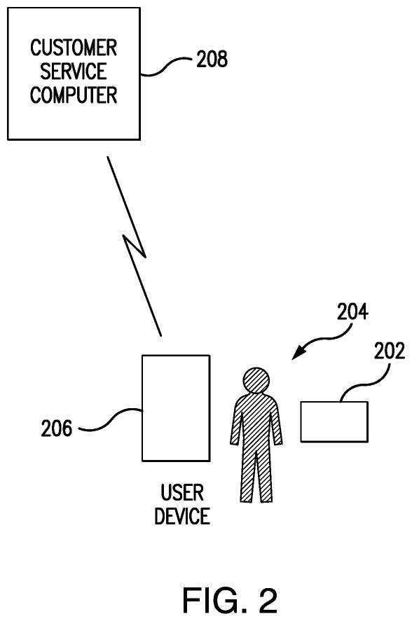

FIG. 5 is a block diagram that illustrates further aspects of the system of FIG. 2.

FIG. 6 is a block diagram that illustrates a computer that may perform functions in connection with the system of FIGS. 2 and 5.

FIGS. 7 and 8 are flow charts that respectively illustrate processes that may be performed in the system of FIGS. 2 and 5 in accordance with aspects of the present disclosure.

### DETAILED DESCRIPTION

In general, and for the purpose of introducing concepts of novel embodiments described herein, account holders may be permitted to purchase IC payment cards that at the time of purchase are not linked to any payment account or other set of payment credentials.

In some embodiments, the purchased payment cards may be contactlessly readable. The purchasing account holder may access a service provider's website to link the purchased IC payment card to a previously existing payment card system account owned by the account holder. The account holder may upload a card identification number to the website. The account holder may also upload the account number that identifies his/her payment card account. With the card identification number, the service provider may look up a PAN (primary account number) or payment token that has been previously stored in the purchased IC payment card. The service provider may establish a database entry that links the IC card payment token to the account holder's previously existing payment card account.

In subsequent use of the payment card by the account holder, the PAN/token is read from the card, and processed in the system so as to route the transaction to the account holder's payment card account.

Assuming that the purchased IC payment card is a contactless card, the account holder may find it more convenient to use for various transactions than a non-contactless IC payment card that was previously issued to the account holder by the account issuer. Moreover, for at least some situations, the purchased IC payment card may be more convenient to use for a given transaction than a payment-enabled mobile device. Thus an effect of the teachings of the present disclosure is to increase the efficiency and improve the accompanying user experience for purchase transactions that entail exchanges of electronic data messages between a customer device and a user device at the point of sale. This occurs via a technical solution that results in a user-initiated linking of an “off the shelf” unlinked IC payment card with the user's preexisting payment card account.

FIG. 2 is a block diagram that illustrates aspects of an embodiment of a card-to-account linking system 200 provided in accordance with aspects of the present disclosure.

FIG. 2 shows an unlinked payment IC card 202 that has, e.g., been purchased by a user/account holder 204. FIG. 2 further shows the user operating a user device 206 to interact with a customer service computer 208 via, e.g., the internet (not shown).

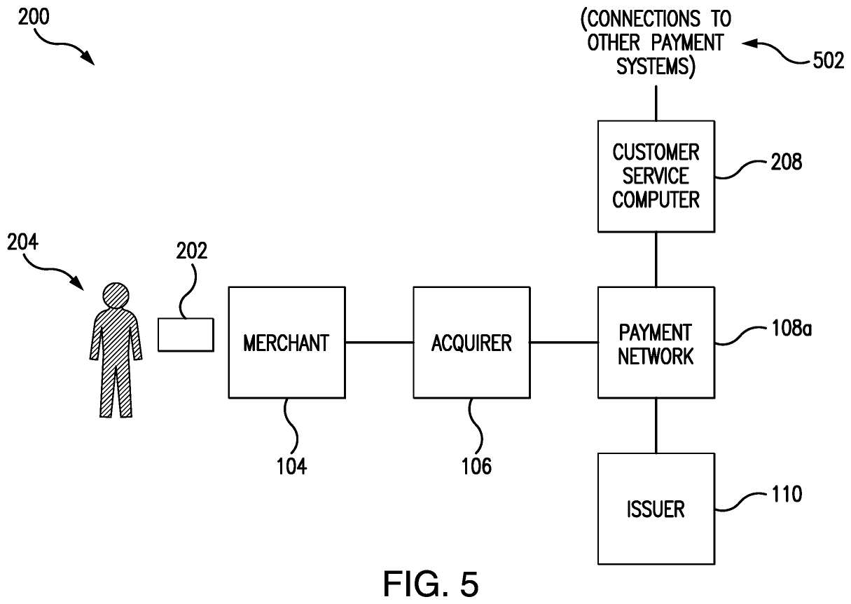

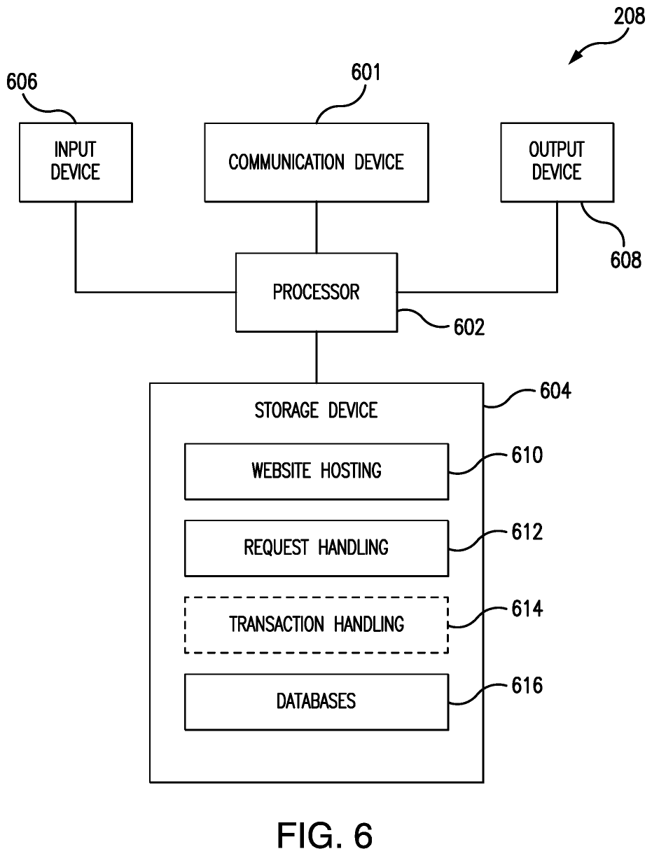

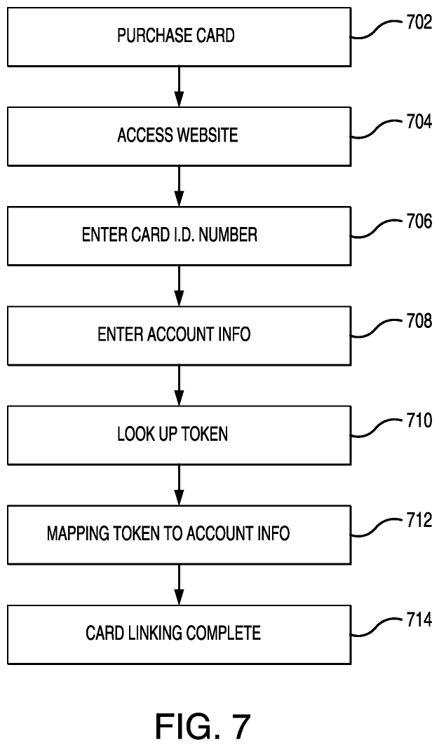

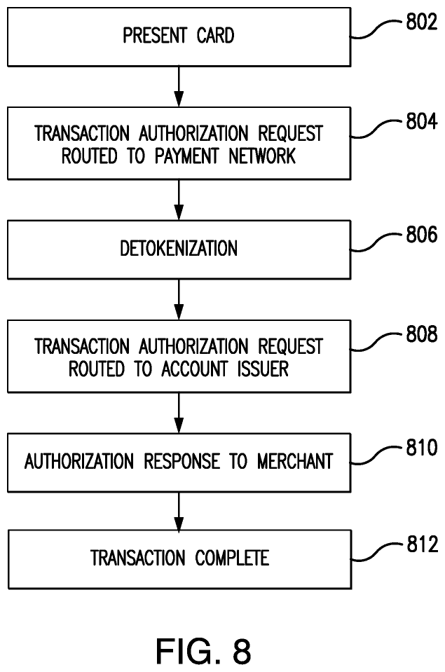

Some details of the payment IC card 202 will be described below in connection with FIGS. 3 and 4. Aspects of the customer service computer 208 will be discussed below in connection with FIG. 6 and at least some of the functions of the customer service computer 208 will be explained below in conjunction with FIGS. 7 and 8.

The user device 206 may be a conventional smartphone or other mobile device, or a personal computer or notebook computer, or any other device that runs a browser or app that supports interaction with the customer service computer 208. As such, as will be generally understood, the user device may include a processor (not separately shown) programmed with program instructions stored in one or more memory devices (not separately shown) in the user device 206.

In general, the interaction illustrated in FIG. 2 may be for the purpose of linking the payment IC card 202 to a payment card account (or other account) previously issued to the user 204. Details of the interaction will be discussed below in conjunction with FIG. 7.

FIG. 3 is a simplified plan view of an example embodiment of the payment IC card 202 shown in FIG. 2. In overall appearance, the payment IC card 202 may resemble a typical payment ID card. For example, it may in its obvious appearance show that it is made largely of plastic, and may conform to the physical form factor prescribed for the standard “ID1” card, as alluded to below. The payment IC card 202 may lack much or all card-specific visible data in terms of what is displayed on the front and back of the card. It may bear a card identification number (not shown) to be used in the link-to-account process, but alternatively the card identification number may only be displayed on packaging associated with the card at the time the card is purchased. The card may also bear a phone number and/or web address for use in the linking process, but these too are not shown in the drawing, and may in some embodiments be borne on the packaging for the card. There may be a modest amount of visible branding on the card, e.g., branding associated with a company that distributes the cards for sale in retail outlets. If the payment IC card 202 is a “contact” card as well as a “contactless” card, then electrically conductive contacts (not shown in FIG. 3) may be present on the face of the card according to the requirements of an appropriate standard governing payment IC cards. In some embodiments, the payment IC card 202 may also be a magnetic stripe card, although the magnetic stripe is not indicated in the drawings.

FIG. 4 is a schematic plan view showing internal components of the example payment IC card 202 shown in FIG. 3.

Referring to FIG. 4, in this embodiment, the payment IC card 202 has a support structure 402 with an outer surface that defines a card-shaped body. The card shaped body may be formed of plastic or other suitable material and may resemble conventional payment cards in shape and size. In some embodiments, the card shaped body has dimensions defined for the standard card referred to as “ID1” in ISO/IEC standard 7810, promulgated by the International Standardization Organization.

In this embodiment, the payment IC card 202 further includes an IC 403 and an antenna 406. The IC 403 includes control/storage circuitry and transmit/receive circuitry, both of which are not shown apart from the IC 403.

The antenna 406 may be mounted in, embedded in and/or otherwise supported by the card-shaped body. As shown, the antenna 406 may comprise several loops arranged along the periphery of the card-shaped body. Alternatively, the antenna 406 may be of a different type and/or configuration.

The IC 403 may include electrically conductive contact pads 410, 412 via which the transmit/receive circuitry of the IC 403 may be electrically connected to the antenna 406.

The payment IC card 202 may also include a conventional set of contacts 420 (schematically represented in FIG. 4) located on a front surface 422 of the support structure 202. The contacts may take the form of electrically conductive pads and may be laid out in a pattern prescribed in an applicable international standard for contact IC identification cards. The contacts 420 may be suitably coupled to the IC 403 of the payment IC card 202, to enable the payment IC card 202 to function (once linked to the account holder's account) as a contact payment IC card.

The IC 403 stores a payment token or PAN that is to be linked to the purchasing user's payment account, such that the payment token/PAN serves in the same role as a payment token in a payment system tokenization scheme, such as are known to those who are skilled in the art. The payment token/PAN stored in the IC 403 is advantageously different from the card identification number mentioned above, which is displayed on the card or card packaging and which is used in the process of linking the payment token/PAN to the user's payment account.

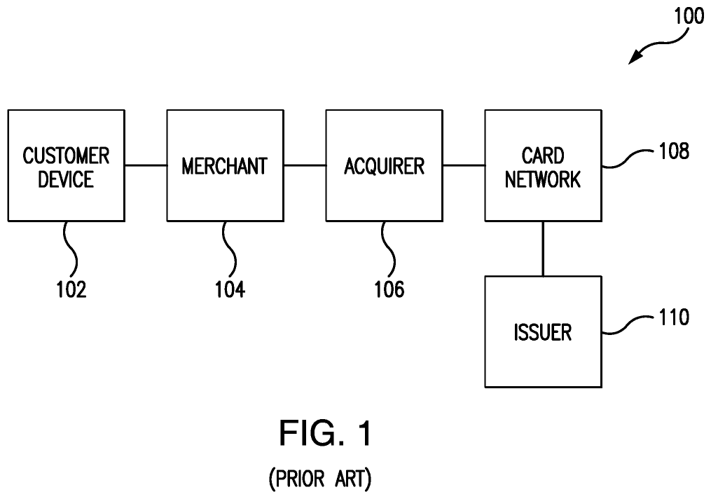

FIG. 5 is a block diagram that illustrates further aspects of the system 200 of FIG. 2. From ensuing discussion, it will be appreciated that the system 200 incorporates many or all features of the payment system 100 discussed above in connection with FIG. 1, with additional capabilities not offered by a conventional payment system.

FIG. 5 shows the user 204 presenting the payment IC card 202 to a merchant device 104. It may be assumed that the purchase transaction scenario illustrated in FIG. 5 takes place after the card-to-account-linking scenario illustrated in FIG. 2.

As before, the merchant device 104 is in communication with an acquirer 106, which, in turn, communicates with a payment network 108a. The payment network 108a may have all the capabilities of the card network 108 discussed above in connection with FIG. 1, and may have additional functionality as described in this disclosure. The payment network 108a is in communication with an account issuer 110 and with a customer service computer 208, which may be the same as the customer service computer 208 shown in FIG. 2. In other arrangements, the customer service computer shown in FIG. 5 may be separate from that shown in FIG. 2, but may be operated in coordination with the other customer service computer. The customer service computer(s) 208 may be operated by or on behalf of the company that distributes the unlinked payment IC cards for sale in retail stores, for example.

In some embodiments, the customer service computer 208 may have connections to other payment systems (as indicated at 502) in addition to the payment system centered on the payment network 108a.

As will be understood from subsequent discussion, in its role as shown in FIG. 5, the customer service computer 208 may in some ways be thought of as performing as a “token service provider” as that term is used in tokenization schemes that have been proposed for payment systems.

FIG. 6 is a block diagram of an example embodiment of the customer service computer 208 shown in FIGS. 2 and 5.

The customer service computer 208, in its hardware aspects, may resemble a typical server computer and/or mainframe computer, but may be controlled by software to cause it to function as described herein. In addition, the customer service computer 208 may be designed as a special purpose computer, and thus specially configured to perform the functions described herein.

The customer service computer 208 may include one or more processor(s) 602 operatively coupled to a communication device 601, a storage device 604, an input device 606 and an output device 608. The communications device 601, the storage device 604, the input device 606 and the output device 608 may all be in communication with and/or operably connected to the processor(s) 602. The processor(s) 602 operate to execute processor-executable steps, contained in program instructions described below, so as to control the customer service computer 208 to provide desired functionality.

Communication device 601 may be used to facilitate communication with, for example, other devices (such as user devices and/or the payment network 108a). Communication device 601 may comprise numerous communication ports (not separately shown), to allow the customer service computer 208 to communicate simultaneously with a number of other computers and/or other devices, including communications as required to simultaneously handle numerous interactions with other devices which may be associated with numerous transactions, and requests to link cards to accounts.

Input device 606 may comprise one or more of any type of peripheral device typically used to input data into a computer. For example, the input device 606 may include a keyboard and a mouse. Output device 608 may comprise, for example, a display and/or an audio speaker, and/or a printer.

Storage device 604 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as flash memory and the like. Any one or more of such information storage devices may be considered to be a non-transitory computer-readable storage medium or a computer usable medium or a memory.

Storage device 604 stores one or more programs for controlling the processor(s) 602. The programs comprise program instructions (which may be referred to as computer readable program code means) that contain processor-executable process steps of the customer service computer 208, executed by the processor(s) 602 to cause the customer service computer 208 to function as described herein.

The programs may include one or more conventional operating systems (not shown) that control the processor(s) 602 so as to manage and coordinate activities and sharing of resources in the customer service computer 208, and to serve as a host for application programs (described below) that run on the customer service computer 208.

The programs stored in the storage device 604 may include, for example, a program 610 to support hosting of a website by the customer service computer 208.

Another program that may be stored in the storage device 604 is an application program 612 to support handling of card-to-account linking requests by the customer service computer 208.

Assuming that the customer service computer 208 is involved in payment transactions as well as card-to-account linking, the storage device 604 may also store a transaction handling application program 614. The transaction handling application program 614 may control the processor(s) 602 to enable the customer service computer 208 to perform its role in payment transactions in a manner that will be described below.

The storage device 604 may also store, and the processor(s) 602 may also execute, other programs, which are not shown. For example, such programs may include communications software and one or more reporting applications. The latter program(s) may respond to requests from system administrators, for example, for reports on the activities performed by the customer service computer 208. The other programs may also include, for example, device drivers, database management software, and the like.

In addition, the storage device 604 may store one or more databases 616 that may be required for operation of the customer service computer 208. The databases 616 may include a database (not separately shown) that stores data to link card tokens/PANS to the payment accounts of the purchasers of the cards. The latter database in effect enables the customer service computer 208 to function as a token vault/token services provider.

Each block in FIG. 5 should be understood to represent both the indicated entity and one or more computers operated by or on behalf of the respective entity. It should be understood that computerized components of the system 200 (as seen in FIG. 5) may be constituted by computer hardware having the same types of components and/or hardware architecture as described herein with reference to FIG. 6.

FIG. 7 is a flow chart that illustrates a process that may be performed in the system 200 in accordance with some embodiments of the disclosure. In particular, FIG. 7 illustrates a card-to-account linking process, as illustrated by the scenario depicted in FIG. 2.

At 702 in FIG. 7, the user 204 obtains an “unlinked” card 202, e.g., by purchasing it in a retail store (not shown).

At 704, using information presented on the card or card packaging, and by interacting with the user device 206, the user 204 accesses the website hosted by the customer service computer 208. In some embodiments, the customer service computer 208 is operated by or on behalf of the company that distributes the unlinked cards for sale in stores.

At 706, in response to a prompt or instruction provided by the website, the user 204 interacts with the user device 206 to enter the card identification number displayed on the card 202 and/or the card packaging. In doing so, the user 204 is providing the card identification number to the customer service computer 208.

At 708, again in response to a prompt or instruction provided by the website, the user 204 interacts with the user device 206 to enter the PAN for the payment account (previously issued to the user by an account issuer), where the PAN entered at 708 represents the payment account to which the user 204 wishes the card 202 to be linked. (At this stage, the user 204 may also be prompted to enter additional information regarding the payment account, including the current expiration date borne on a card (not shown) previously issued to the user 204 by the account issuer and associated with the payment account.

At 710, the customer service computer 208 uses the card identification number entered (received by the customer service computer 208) at 706 to look up the token/PAN that was/is stored in the card 202. In doing this, the customer service computer 208 may access one of the databases represented at block 616 in FIG. 6.

At 712 in FIG. 7, the customer service computer 208 maps the card token/PAN looked up at 710 to the PAN entered by the user 204 at 708. This may be done by a suitable entry in a “token vault” database, which, as mentioned above, may be one of the databases represented at block 616 in FIG. 6.

At this point the card-linking operation is complete, as indicated at 714 in FIG. 7, and as may be communicated to the user 204 from the customer service computer 208 website via the user device 206. With completion of the operation, the user 204 is now able to utilize the card 202 purchased at 702 to access the payment account represented by the PAN entered by the user at 708. As will be understood from previous discussion, the card 202 may be usable in contactless transactions at the point of sale for access to the payment account, thereby providing a convenient functionality that may not have been previously available to the user 204.

In some embodiments, the card-to-account linking process of FIG. 7 may include a user authentication step (not indicated in the drawing) to enhance security of the system 200.

The mapping of the card token/PAN to the user's payment account may not occur, or may not be effective, until user authentication is successfully performed. In some embodiments, user authentication may involve participation of the account issuer and/or cooperation between the customer service computer 208 and the account issuer.

FIG. 8 is a flow chart that illustrates a process that may be performed in the system 200 in accordance with some embodiments of the disclosure. In particular, FIG. 8 illustrates a payment transaction process, as illustrated by the scenario depicted in FIG. 5.

At 802 in FIG. 8, the user 204 presents the payment IC card 202 to the merchant device 104. This may occur, for example, in the context of a purchase of goods at a retail store where the merchant device 104 is located. In some situations, the payment IC card 202 is presented so as to be contactlessly read by a reader component (not separately shown) of the merchant device 104. That is, the payment IC card 202 may be tapped by the user 204 on the reader component for the contactless reading of the payment IC card 202. According to other possibilities, the payment IC card 202 may be read by the reader component via contacts on the payment IC card 202, or the payment IC card 202 may be “swiped” through the reader component for reading of a magnetic stripe (not shown) on the payment IC card 202.

During the reading of the payment IC card 202, the merchant device 104 may read the token/PAN stored in the payment IC card 202. The merchant device 104 may generate a payment account system transaction authorization request message, including the payment token read by the reader component as the payment account number information for the transaction authorization request message. The merchant device 104 may also include transaction and merchant information and other information in the transaction authorization request message.

At 804 in FIG. 8, the transaction authorization request message may be routed from the merchant device 104 via the acquirer 106 to the payment network 108a. The payment network 108a may detect that a portion of the token/PAN in the transaction authorization request (that portion possibly being the so-called “BIN” or bank identification number) indicates that detokenization is required via the customer service computer 208. At 806 detokenization proceeds. That is, the payment network 108a transmits, to the customer service computer 208, the token/PAN from the transaction authorization request message. (In some embodiments, the payment network 108a also transmits, to the customer service computer 208, some or all other portions of the transaction authorization request message.) As part of the detokenization, the customer service computer 208 looks up the account PAN to which the particular card token/PAN has previously been mapped by the customer service computer 208.

For the moment, it is assumed that the account PAN identifies the user's payment account issued by the account issuer 110. Consequently, the customer service computer 208 transmits the account PAN to the payment network 108a. The payment network 108a then replaces the card token/PAN in the transaction authorization request message with the account PAN, and next routes the transaction authorization request message to the issuer 110, as indicated by block 808 in FIG. 8.

At 810 in FIG. 8, a transaction authorization response message generated by the issuer 110 is routed back to the merchant device 104 via the payment network 108a and the acquirer 106. The purchase transaction at the point of sale is then completed, as indicated by block 812.

The discussion up to this point has assumed that the card token/PAN was mapped to a payment account issued in a payment card account system centered on the payment network 108a. In other embodiments, that need not necessarily be the case.

For example, in some embodiments, the card token/PAN may have been mapped to a payment account issued in a payment card account system different from the payment card account system centered on the payment network 108a. In such embodiments, upon detokenization, the customer service computer 208 may bridge the payment transaction to that different payment card account system.

In other embodiments, the card token/PAN may be mapped to the user's bank account and/or a facility for the user to make payments via ACH (automated clearing house) transactions. In such embodiments, upon detokenization, the customer service computer 208 may bridge the payment transaction to an ACH system or other payment mechanism different from the payment card account system centered on the payment network 108a.

In some embodiments, the payment IC cards utilized for linking to previously existing accounts may include a component or components for implementing biometric security measures such as fingerprint scanning.

With systems and processes as disclosed herein, a novel data gathering, processing and mapping process performed at a customer service computer enables payment account owners to obtain additional technological functionality for accessing their payment accounts. This may include the ability to conveniently acquire, set up and then use contactless payment IC cards to improve the convenience and throughput of transactions carried out via electronic messaging at locations such as a retail point of sale or a mass transit entry point. The entire messaging functionality of a payment system may be enhanced, without requiring card account issuers to take on the cost of routinely supplying contactless cards to all account holders.

The unlinked-card-later-linked-to-payment-account arrangement described herein may further provide enhanced convenience in comparison with a payment-enabled smartphone. For one matter, the card-purchase-and-linking process may prove more convenient for account holders than obtaining personalization of a smartphone. Moreover, during the performance of a reading transaction, less effort may be required of a user of a payment IC card as described herein than in using a payment-enabled smartphone, because with the card no preliminary step such as opening a wallet app would be required. Still further, for those who frequently upgrade their smartphones, the linked card may offer the convenience of a relatively long useful life of several years, in contrast to what might otherwise be necessary with payment-enabled mobile smartphones, i.e., personalizing a new smartphone for payment purposes every year or two.

In cases where the unlinked payment IC card includes a biometric reader, the user's adoption of the card and linking of it to his/her payment account effectively enhances the security of transactions involving the payment account, assuming the adopted card is used in such transactions.

In some embodiments, the process of linking the card may include setting up a PIN (personal identification number) so that “chip plus PIN” transactions are enabled with the adopted card. This too may enhance the security of transactions involving the linked payment account.

In some embodiments, the unlinked payment IC card may lack a magnetic stripe, thereby enhancing security by making it more difficult for a wrongdoer to “clone” the card.

There may also be security benefits in the cases where the token/PAN stored in the card chip does not appear on the exterior of the card.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment system” refers to a system for handling purchase transactions and related transactions. An example of such a system is the one operated by Mastercard International Incorporated, the assignee of the present disclosure. In some embodiments, the term “payment system” may be limited to systems in which member financial institutions issue payment accounts to individuals, businesses and/or other organizations.

The above descriptions and illustrations of processes herein should not be considered to imply a fixed order for performing the process steps. Rather, the process steps may be performed in any order that is practicable, including the omission of one or more steps and/or the simultaneous performance of at least some steps.

As used herein and in the appended claims, information “displayed in association with a card” includes such information printed or otherwise made available for viewing on the card itself or on packaging in which the card is contained or on which the card is supported.

As used herein and in the appended claims, the term “payment credentials” refers to a payment account number or a payment account number and related account information or a bank account number or data required to initiate an ACH transaction.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

Although the present disclosure describes specific exemplary embodiments, it should be understood that various changes, substitutions, and alterations would be apparent to those skilled in the art and can be made to the disclosed embodiments without departing from the spirit and scope of the disclosure as set forth in the appended claims.

What is claimed is:

1. A method comprising:
receiving a request from an account holder to link a payment card to a payment card account owned by the account holder, the receiving of the request including receiving a payment card identification number displayed in association with the payment card;
using the payment card identification number received in the request to look up a payment token electronically stored in the payment card, said payment card identification number different from said payment token; and
mapping the payment token to a payment card account number that identifies said payment card account owned by the account holder.

2. The method of claim 1, wherein said payment card includes a biometric reader.

3. The method of claim 1, further comprising:
defining a PIN (personal identification number) that is applicable to transactions in which the payment card is used.

4. The method of claim 1, wherein said payment card does not include a magnetic stripe.

5. The method of claim 1, wherein the payment card identification number is printed on the payment card.

6. The method of claim 1, wherein:
the payment card identification number is printed on packaging that contains the payment card; and
the payment token stored in the payment card is not visually presented on the payment card.

7. The method of claim 1, wherein the payment card is a contactless IC (integrated circuit) payment card.

8. The method of claim 7, wherein the payment card is a contact IC payment card.

9. A method comprising:
receiving a request from an account holder to link a payment card to a payment card account owned by the account holder, the receiving of the request including receiving a payment card identification number displayed in association with the payment card;
using the payment card identification number received in the request to look up a primary account number (PAN) electronically stored in the payment card, said payment card identification number different from said PAN; and
mapping the PAN to a payment card account number that identifies said payment card account owned by the account holder.

10. The method of claim 9, wherein said payment card account owned by the account holder is a credit account.

11. The method of claim 9, wherein said payment card account owned by the account holder is a debit account.

12. The method of claim 9, wherein said payment card account owned by the account holder is a prepaid account.

13. The method of claim 9, wherein the payment card identification number is printed on the payment card.

14. The method of claim 9, wherein the payment card identification number is printed on packaging that contains the payment card.

15. The method of claim 9, wherein the payment card is a contactless IC (integrated circuit) payment card.

16. The method of claim 15, wherein the payment card is a contact IC payment card.

17. A method comprising:
receiving a request from a user to link a payment card to a set of payment credentials associated with the user, the receiving of the request including receiving a payment card identification number displayed in association with the payment card;
using the payment card identification number received in the request to look up a payment token electronically stored in the payment card, said payment card identification number different from said payment token; and
mapping the payment token to the set of payment credentials.

18. The method of claim 17, wherein said set of payment credentials includes a bank account number that identifies a bank account owned by the user.

19. The method of claim 17, wherein said set of payment credentials includes credentials required to initiate an ACH (automated clearing house) transaction on behalf of the user.

20. The method of claim 17, wherein the payment card is a contactless IC (integrated circuit) payment card.
